(19) United States
(12) Patent Application Publication
(10) Pub. No.: US 2005/0204378 A1
(43) Pub. Date: Sep. 15, 2005

(54) System and method for video content analysis-based detection, surveillance and alarm management

(76) Inventor: Shay Gabay, Kadima (IL)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/510,358

(22) PCT Filed: Mar. 10, 2004
(86) PCT No.: PCT/IL04/00231

§ 371 Date: Oct. 5, 2004

(51) Int. Cl. H04N 7/16; G06F 17/60; H04H 9/00

(52) U.S. Cl. 725/13; 725/135

(57) ABSTRACT

An apparatus, system, and method for the creation of interaction requests during or after a base interaction. The interaction requests are put into feedback and action forms and are based on content of the base interaction, created in order to be used as drivers for the execution of follow up interactions associated with the base interaction.

### BACKGROUND OF THE INVENTION

1. Field of the Invention

The present invention relates to the analysis of interactions in general, and more particularly to the administering of a survey and to acquiring of interaction information from participants of an interaction session.

2. Discussion of the Related Art

Business organizations increasingly regard the conduct of interactions with their customers as major sources of information and insight regarding business operations as reflected by the opinions of the customers and of the service provider personnel, such as agents, regarding the conduct and management of the interactions.

Surveys are information collection techniques that involve a pre-defined set of structured and standardized questions. When the questions are administered by the respondents, the survey is referred to as a questionnaire, or a self-administered survey. In order to obtain useful interaction information the set of pre-defined questions constituting a standard questionnaire could be pre-produced by the organization and the questionnaire could be presented to the participants as a feedback form at the end of the interaction. The presentation of the feedback form provides the option for the participants to express their opinions by responding to a set of pre-defined questions constituting the content of the feedback form. The responses typically involve the insertion of a group of answers to the respective questions. The questions are structured and constructed such that the responses will reflect their opinions, reactions, attitudes, and interaction-specific comments concerning the conduct and the management of the interaction. Thus, the presentation of the feedback form enables the performance of a post-interaction follow-up procedure associated with the interaction. By obtaining, processing and analyzing the responses associated with the feedback forms the organization is understood to attain useful information.

In interaction analysis, the above-described approach has several drawbacks. The main drawback concerns the inherent characteristics of the existing survey techniques vis-à-vis the specific demands of interaction information acquirement. Currently utilized surveys are designed for the collection of large samples of statistical or quantitative information and fail to obtain quality-oriented and event-focused interaction related information. In existing survey techniques, the questions are standardized in order to reduce bias and to ensure reliability, generality, and validity. Every respondent is presented with the same questions and in the same order as the other respondents. As a result, where employed for interaction analysis, standard questionnaires lack the flexibility to address specific aspects of a specific interaction and lack the capability of handling dynamically developing personality issues. The set of standard questions is not intended to relate to specific events that could occur during a specific interaction. The same questionnaire is introduced for each interaction and for each participant, and the respondents are required to submit answers to the same set of questions regardless of the duration, the complexity, the dynamics, the level of understanding of the customer, the customer's propensity to respond to a follow up survey or questionnaire, the level of details the customer was interested in, and the final results of the interaction.

It will be easily perceived by one with ordinary skills in the art that a novel apparatus and method is required for performing a substantially more efficient interaction-specific survey.

### SUMMARY OF THE PRESENT INVENTION

It is an object of the present invention to provide a novel apparatus, system, and method for the creation of a dynamic and adaptive feedback and action form utilized for the execution of a follow up interaction that is associated with an base interaction performed by a customer and one or more representatives.

One aspect of the present invention regards an apparatus for the acquirement of interaction management information. The apparatus comprises the elements of an base interaction recording handler for processing an at least one interaction episode occurring within an base interaction, an information request generator for generating an at least one information request associated with the at least one interaction episode, a feedback and action form builder for building an at least one feedback and action form associated with the base interaction and including the at least one information request associated with the at least one interaction episode, and a follow-up interaction manager for receiving and handling a response to the at least one information request in the at least one feedback and action form.

A second aspect of the present invention regards a method for obtaining interaction management information. The method comprises the steps of: analyzing the recording of an base interaction performed via a summed channel or other channels, the channels are associated with interaction participants, for identifying an at least one interaction episode occurring during the base interaction, selecting an at least one information request in accordance with characteristics, content, and context of the at least one interaction episode and the characteristics of an at least one interaction participant, creating a two-way or a multi-way logical link between the at least one interaction episode and the at least one information request, inserting the at least one information request into an at least one feedback and action form, creating a two-way or a multi-way logical link between the base interaction and the at least one feedback and action form, and executing an at least one follow-up interaction with an at least one base interaction participant, utilizing the at least one feedback and action form created during or after the base interaction, for obtaining interaction management information regarding the events occurred during the base interaction.

### BRIEF DESCRIPTION OF THE DRAWINGS

The present invention will be understood and appreciated more fully from the following detailed description taken in conjunction with the drawings in which:

FIG. 1 is a general block diagram of the of the proposed apparatus, on accordance with a preferred embodiment of the present invention;

FIG. 2A, 2B, 2C, 3A, 3B, and 3C are detailed block diagrams of the constituent components of the proposed apparatus, in accordance with a preferred embodiment of the present invention;

FIG. 4 illustrates the structure of the feedback and action form in relation with the constituent interaction episodes of the base interaction recording;

FIG. 5 is a flowchart describing the operation of the proposed method, in accordance with another preferred embodiment of the present invention; and

FIG. 6 is a flowchart describing an alternative operation of the proposed method, in accordance with another preferred embodiment of the present invention.

### DETAILED DESCRIPTION OF THE PREFERRED EMBODIMENT

The present invention discloses a new and novel interaction analysis method and apparatus. The present invention provides an apparatus, system, and method for the creation of dynamic and adaptive interaction follow up form utilized for the execution of a follow up interaction that is associated with an interaction that took place between a customer and one or more representatives. The invention involve the generation of an interaction-specific dynamic form that is created adaptively during and in accordance with the dynamics of an interaction between a customer and or more representative. Alternatively the form can be generated in response to an interaction between any two parties. The follow up form in the framework of the follow-up interaction provides the participants to relate to particular aspects of the interaction. For example, as a result of a base interaction between a customer and representative, a follow up interaction takes place in which the customer or the representative complete a follow up survey which is provided as a follow up form, automatically generated. The follow up form is generated in response to the base interaction. The base interaction can be an audio recording or any other multimedia stream that is exchanged between the parties to a conversation. Such media can include video, audio, data of all kinds, including, data over data networks, such as data over IP, World Wide Web browsing, short messages system data over wireless networks, and any other type of media. The same data stream which includes the multimedia embodying the interaction can also include date about the interaction and such can be extracted and used in the context of the present invention. Once the interaction between the parties is captured a follow up form is prepared in real time. While the present text describes mainly the process once a base interaction has been captured it would likewise function after the interactions, whether base or follow up, are recorded, stored or later extracted. The follow up form can be prepared automatically during or after the capture of the base interaction itself and in response to predetermined events within the base interaction. Alternatively, the follow up form can be prepared once the base interaction is complete. A follow up interaction is then initiated automatically or by a human representative and the follow up form is shown to the party taking the survey. This follow up interaction can in itself be considered as a base interaction and a follow up form prepared in connection there to. Each part of the base interaction or later one or more follow up interactions can serve as the basis for another follow up interaction. Thus, there is no limit for the number of follow ups which can take place. It would be evident to those skilled in the art that a limited number of follow up interactions can take place with respect to a base interaction comprising an interaction between a customer and a representative in a call center. However, in other eventualities, such as in interactions between two professionals the number of follow up interactions can increase. In yet another alternative, the follow up forms can be built for representatives who would provide the survey over the phone to customers. Another feature of the present invention is the inclusion of actions to be generated as part of the follow up forms. Such actions can include an instructions to direct the person answering the follow up form to a particular service or issue an instructions to representative in response to an answer received from a person performing the follow up form during or after the follow up interaction. The present known systems where interactions between customers and representatives take place are based on telephony communications, thus, the first application of the present invention would be in connection with such systems, Future systems providing interactions via electronic media would enable providing the follow up form in a follow up interaction via electronic media and data or other networks.

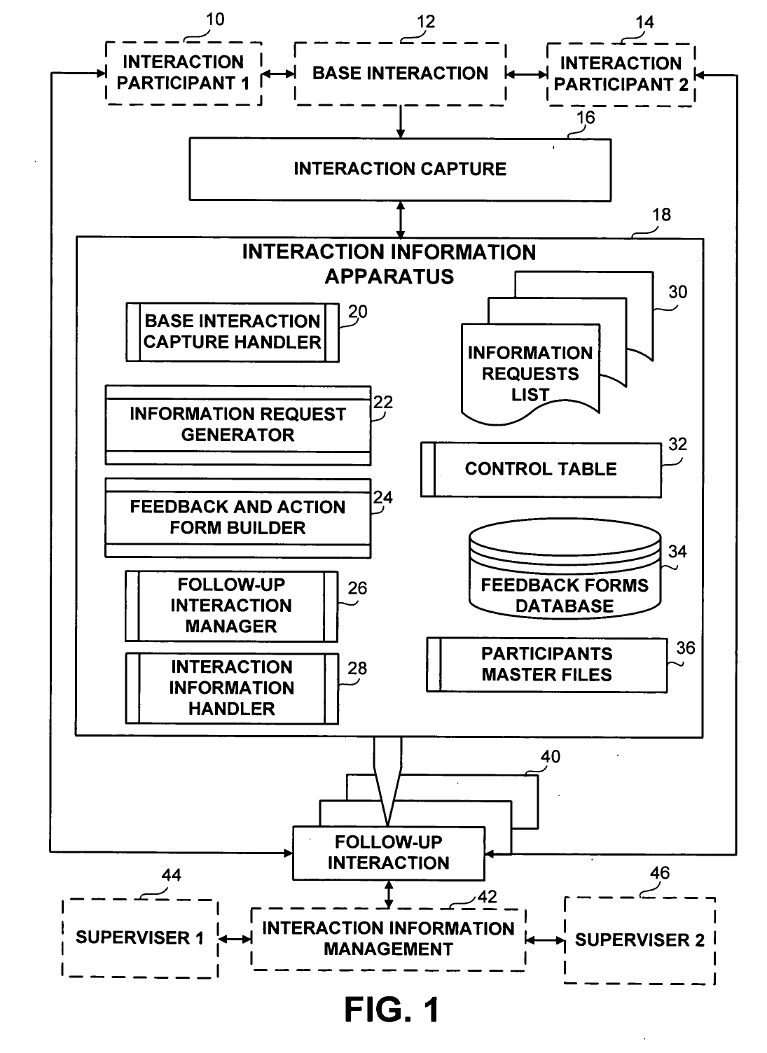

Referring to FIG. 1 a base interaction 12 is a communicative session in which information is exchanged between two or more participants 10, 14. An interaction is defined as a communication session within which relevant content is exchanged between participants. The interaction could be performed in a conventional manner where the participants engage in a face-to-face real-time conversation or could be performed via man-made artificial communication channels, such as a conventional telephone network, a cellular communication network, audio, and video or text exchange performed via a data communication network, and the like. Additional details with respect to face-to-face interactions can be further seen in PCT Patent application titled RECORDING AND QUALITY MANAGEMENT SOLUTIONS FOR WALK-IN ENVIRONMENTS publication serial number WO03/021927A2 dated 13 Mar. 2003. Interactions typically involve the exchange of audio (voice) streams, video streams, text messages, audio, video and data packets, multi-media and the like. In the preferred embodiment of the invention the interaction 12 is an interaction performed between one or more representatives and a customer. Alternatively, the interaction is performed between one or more representatives with one or more customers. Alternatively, the interaction is performed between two or more representatives. The present invention is not limited to particular parties to the interactions. Any person or machine can be a party to an interaction, whether a base or a follow up interaction. The base interaction 12 could take place in a face-to-face manner or could be performed via artificial man-made communication systems, such as a telephone network, a cellular network, a data communication network, and the like. Thus, the base interaction 12 could be based on diverse interaction media, such as audio, video, text, multi-media and the like. In the preferred embodiment of the invention the interaction 12 is captured by an interaction capturing device 16. The capture may be performed in real time or off line. When performed off line there will be a data accumulation in a buffer or the data captured will be stored, such as on a disk or other media, and later processed. The interaction capture device 16 can be a microphone, a video camera, a keyboard, a touch screen or any other capturing device which can capture any part of the interaction. The interaction may alternatively be recorded into a magnetic or optical or other media to provide an interaction recording. An Interaction Information apparatus is used to generate the follow up forms in accordance with data and events associated with the interaction capture 16. The Interaction Information apparatus 18 is one or a group of logically interrelated computer modules installed on a computing platform, such as on a personal computer. The apparatus 18 could be implemented as executable object code stored in a magnetic or optical storage device associated with the computing platform. Alternatively, the modules of the apparatus 18 could be computing instructions encoded into hardware, such as integrated circuit boards associated with a microprocessor. The apparatus 18 is designed to operate during (in real-time) or subsequent to (off-line) the interaction capture 16. The function of the apparatus 18 is to establish dynamically and adaptively a follow-up interaction 40 associated with the base interaction 12. The base interaction 12 is an interaction that took place between two parties, such as between a customer and an agent or representative upon which a follow-up interaction 40 will be conducted. The follow-up interaction 40 is an interaction established to obtain feedback or follow up information from parties to the base interaction 12. The follow-up interaction 40 is also an interaction established to perfom follow up actions associated with the feedback or follow up information from parties to the base interaction 12. The feedback or follow up or follow up actions can be associated with, but is not limited to, the (i) process of the base interaction 12, (ii) the conduct of the representative or another party on the base interaction 12, (iii) the quality and level of service provided, (iv) the personal dynamics occurred, (v) technical problems relating to the base interaction 12, (vi) the expectation of the parties to the interaction, (vii) actions not performed or not completed, and the like. Actions not performed can include for example, incomplete sales, requests for information, requests for documents, and the like. The follow-up interaction 40 is initiated by the interaction information apparatus 18 with one or more participants 10, 14 (agent or customers or others) to the base interaction 12 or to a later follow up interaction 40. The base interaction 12 and the follow up interaction 40 form an integrated information structure established by the generation of a dynamic and adaptive feedback and action form. The feedback and action form contains a set of information requests, such as questions or queries, to be presented to a participant 10, 14 or a set of actions to be performed by a party associated with the interaction, such as a representative, or a combination of questions, queries and actions, some which can be answered and in response thereto others can be performed. For example, the basic feedback and action form can include questions as to the level of service provided by the agent or representative. A more complex form can include a series of actions which must be performed by the representative in view of a base interaction with a customer, such as to call a number of people and report to them as to the base interaction or to send a number of e-mails automatically generated in response to the base interaction. Another form of feedback and action form would include a series of questions the response to which will determine whether a particular action has to be taken, Thus, for example, if the agent did not complete a sale and in the follow up interaction the customer is asked whether he would like to complete the sale and the answer is yes, an action can be generated and automatically performed to transfer the client to another agent to complete the sale or to direct the customer to a web page to complete the sale and the like. The feedback and action form is utilized as the driver of the follow-up interaction 40 and for storing the responses of the participants 10, 14. The feedback and action form is tailored for interaction with one or more participants 10, 14, such as a customer, and representatives (agents) or supervisors or with other parties. The feedback and action form is connected logically via specific link records to the base interaction recording 16 as well to other vital data structures, such as for example customer records and agent records stored in a customer relationship management system. The follow-up interaction 40 is used to provide interaction information that will enable further exploration of conduct of the base interaction 12 as reflected via the opinions of the participants 10, 14 by supervisors 44, 46, to include managers, quality assurance personnel, and the like. The apparatus 18 is further operative in the performance of the follow-up interaction 40. The apparatus 18 is yet further operative in the required handling of the interaction information generated during or after the one or more follow up interactions 40.

Still referring to FIG. 1, the interaction information apparatus 18 comprises a base interaction handler 20, an information request generator 22, a feedback and action form builder 24, a follow-up interaction manager 26, an interaction information handler 28, an information requests list 30, one or more control tables 32, a feedback and action forms database 34, and one or more participants master files 36. Each one of the above components may be operated through one or more computer software modules programmed to achieve the specific operations described below. To operate the system contemplated by the present invention only a number of the modules shown may be required. The handler 20 is responsible for the processing of the interaction capture 16. The handler 20 is functional in identifying the interaction media and the associated interaction participant. Thus, the handler 20 receives a stream of data or an audio stream, identifies a particular episode and extracts the interaction associated with the episode from the media received. The main responsibility of the handler 20 is for identifying and processing an interaction episode that occurred during the base interaction 12 or alternatively a previous follow up interaction 40 from the interaction capture 16 received. An interaction episode is defined as a recorded segment of the base interaction capture 16. The episode can include a predetermined number of seconds before and after an event. One such non limiting event can be a CTI “hold” event. Other exemplary events are described below. This base interaction can also comprise a follow up interaction 40. The interaction episode is conceptually generated by the occurrence of one or more media-specific events either typically initiated by one of the interaction participants 10, 14 or automatically created by the transmission media handlers. Thus, when the base interaction 12 is performed through a telephone network utilizing computer-telephony-integration techniques (CTI), an event could be a “hold” event initiated by a participant, such as a representative. When the base interaction 12 is performed via data communication network, such as the Internet or more specifically the World Wide Web, an event could be a screen event, such as a certain keystroke performed on a connected keyboard or the activation of a certain GUI-based activation button by one of the interaction participants. The event could be based on various content characteristics in the captured media stream 16. For example, in an audio recording or an audio stream a particular tone of voice of one of the participants may be construed as an event. Similarly, the appearance of a certain word or a particular phrase uttered by one of the participants and consequently appearing in the recorded interaction content could be interpreted as an event. An examination text and identification of predetermined text out of speech to text conversion can also be defined as an event. The occurrences of one or more such media-specific events can be captured during the process of capture of the content of the base interaction 12. The handler 20 is responsible for identifying pre-defined events and in accordance with the event characteristics logically form and mark an interaction episode on the interaction capture 16. Additional examples as well as detailed description of the process of identifying an event and defining a media segment related to this event can be seen in co-pending PCT application serial number PCT/IL03/00684 filed Aug. 18, 2003 titled APPARATUS AND METHOD FOR CONTENT ANALYSIS, MARKING AND SUMMING and in co-pending U.S. patent application Ser. No. 10/706,282 filed 13 Nov. 2003 titled APPARATUS AND METHOD FOR EVENT-DRIVEN CONTENT ANALYSIS.

Still referring to FIG. 1 the information request generator 22 receives data regarding the identified episode and in accordance with the content, context, or other characteristics of the episode generates, selects or otherwise obtains one or more information requests. An information request is a question designed to be represented to one or more participants 10, 14 in the framework of the follow-up interaction 40. An information request can also include an action to be performed by the system of the present invention or by a party to the base or follow up interactions or by a third party. An information request can be generated as conditional upon an action or upon a particular answer to a previous information request or conditional upon some other predetermined event or condition. The feedback and action form builder 24 is responsible for collecting the entire set of generated information requests and for inserting the information requests into a machine-readable feedback and action form typically stored in the feedback and action forms database 34. After the capture 16 is processed the feedback and action form is ready to be used. The feedback and action form can later be updated or supplemented. Each feedback and action form can include various avenues of execution and that additional information requests can be added during or after the follow up interaction itself or later follow up interactions. The follow-up interaction manager 26 is responsible for the operation of the one or more follow-up interactions 40. The follow-up interaction 40 is activated automatically by the manager 26 either immediately after the completion of the base interaction 12 or at a pre-determined later point in time. The manager 26 activates the one or more follow-up interactions 40 via a pre-determined interaction media. The activation of the follow up manager can be accomplished manually or according to pre-determined rules set by the controller of the system. Thus, for example, the interaction 40 could be performed by presenting the information requests included in the feedback and action form as audio questions via a telephone network in association with an IVR interface. The manager 26 receives and handles the responses to the follow up interaction. The handling by manager 26 could include validation, verification, error-checking, and the like. The responses could be obtained in a voice format or in a dial tone format accomplished by the appropriate activation of a telephone handset dialing keys by the participant. Alternatively, the follow up interaction 40 could be performed via a data communication network where the feedback and action form is structured into a Web form and sent via electronic means, such as e-mail or a Web site, instant messaging, fax, and the like. As a result to operative limitations different portions of the feedback and action form could be communicated to the interaction participants 10, 14 in a different manner. Thus, some question groups in the form could be presented in a voice format while other question groups could be e-mailed to the participants 10, 14 accompanied with the request that answers should be inserted and the feedback and action form to be e-mailed back a pre-determined address. Manager 26 can in one alternative embodiment be absent where the feedback and action forms are provided to human representatives who call customers in order to pursue the follow up interaction manually. In such scenario the manager 26 can be used and will be useful to keep track of responses to requests put to customers in an orderly fashion.

The interaction information handler 28 is an optional module to be used by supervisors when a review or investigation of an interaction is required. The handler 28 responds to the request of one or more supervisors 44, 48, by accessing interaction information associated with the base interaction 12. The interaction information is generated via the submission of answers or performing of actions by participants 10, 14 to one or more information requests (such as questions or actions) included in the feedback and action form during one or more follow-up interaction 40. The handler 28 further provides the option to the supervisors 44, 46 to navigate between the feedback and action forms, the interaction capture 16 or its recording or the participants master files 36 or any associated later performed follow up interaction 40 and associated data or meta data. The information requests list 30 is preferably an encoded data structure that contains pre-determined information requests indexed in accordance with the interaction episode characteristics, content and context. For example, the information requests can include question such as “Did you find the representative's use of ‘device A’ helpful?” or “Would you like to purchase ‘purchase item A’ now?” and the like. Alternatively, the information request list 30 can include individual words, nouns, adjectives, names and other useful words to create sentences or questions from which the information requests can be built. The information request generator 22 could access the information requests list 30 and obtain the appropriate information request or parts thereof from which an information request can be built in accordance to the episode characteristics received from the interaction capture handler 20. Optional control tables 32 contain various useful parameters regarding the operation of the apparatus. The control tables 32, for example, could store parameters defining the identified episodes, parameters defining the type and number of information requests to be generated for a specific episode, the type of participants, and the like. The feedback and action form database 34 is a data structure storing the feedback and action forms. The feedback and action forms include one or more information request entries, where an entry could include one more information requests to one or more participants, various pointer values connecting the feedback and action form and the information request entries to the interaction capture 16 and to the suitable records in the participant master files 36. The participant master files 36 are data structures storing specific information about the participants. The files 36 could include participant name, participant type (customer, agent), and additional personal data. Note should be taken that the master files 36 could be external to the apparatus 18 and could be implemented in a linked CRM apparatus, an accounting apparatus, a personnel records apparatus, and the like, also remotely to the location of the apparatus 18, linked via a data communications network.

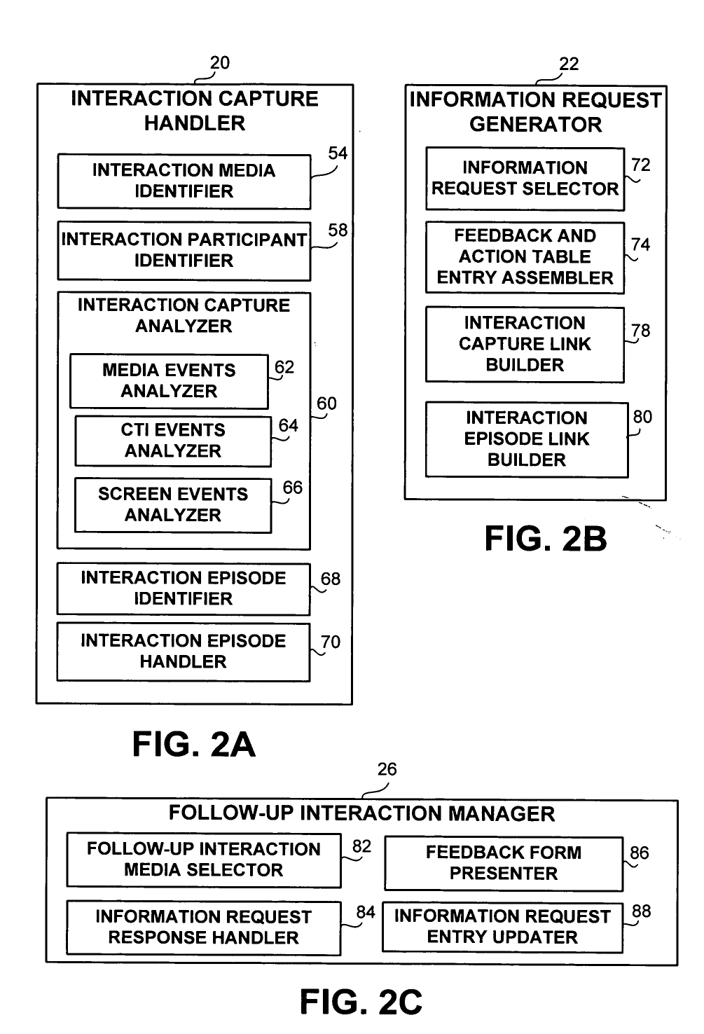

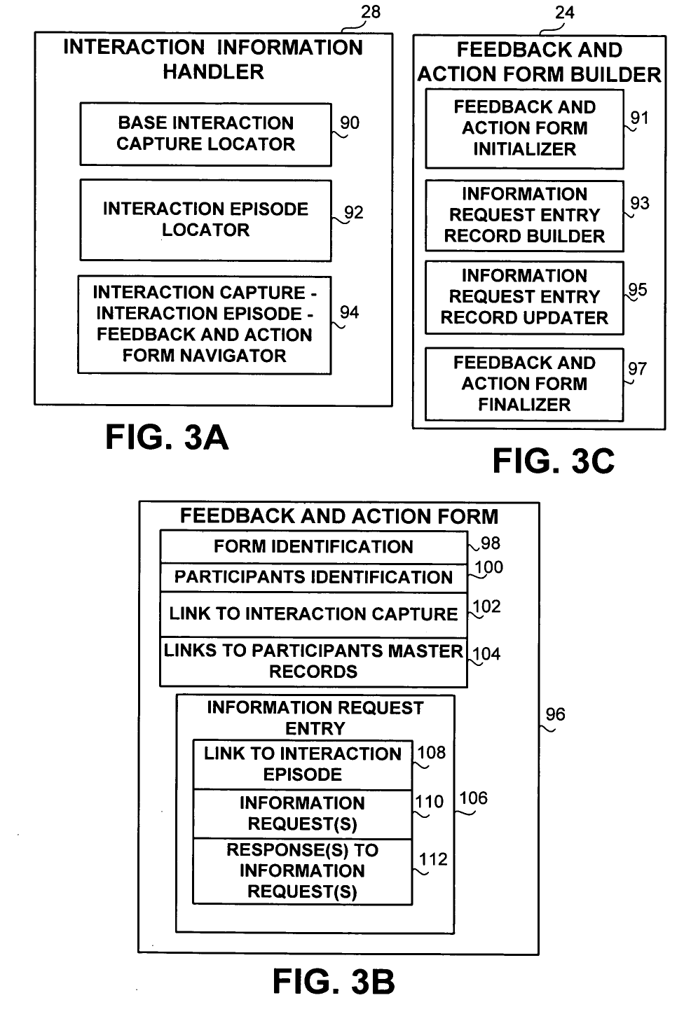

Referring now to FIG. 2A showing an exemplary interaction capture handler designated 20. The interaction capture handler 20 includes an interaction media identifier 54, an interaction participant identifier 58, an interaction capture analyzer 60, an interaction episode identifier 68, and an interaction episode handler 70. Persons skilled in the art will appreciate that a single module or more than the number of modules shown can implement the above stated modules within the interaction capture handler 20. FIG. 2A shows a number of modules for convenience and clarity purposes. The interaction media identifier 54 is responsible for identifying the type and format of the capture of the base interaction or later a follow up interaction upon which another follow up interaction would be performed. The interaction media identifier 54 is also responsible for identifying the part of the media stream associated with each participant of the interaction. If the channels are summed then the system receiving the summed channel and can identify the participants by applying a speaker recognition algorithm. Speaker recognition in this context refers to speak identification and marking each segment of interaction as associated with a particular participant of the interaction. Persons skilled in the art will appreciate that the present invention is also intended to handle summed video, e-mail, chat and other forms of data. The interaction recording analyzer 60 is designed and implemented for analyzing the recorded content of the base interaction or later a follow up interaction upon which another follow up interaction would be performed. The interaction recording analyzer 60 includes typically a set of DSP routines, such as an audio or video or other media events analyzer 62, a CTI events analyzer 64, a screen events analyzer 66, and the like. The media events analyzer 60 could include a word spotter, an emotion detector, a talk analyzer, a speech to text, media content analyzer, media characteristics analyzer, and the like The media events analyzer 62 provides the interaction capture analyzer with the various data necessary to properly analyze the media captured. For example, the media events analyzer would be instrumental in determining when specific words are spoken, or when a particular e-mail is sent, or chat line has been entered or when a physical gesture of a participant is caught on camera. The CTI analyzer 64 identifies CTI events, such as “hold”, “disconnect”, “hook up”, events generated in response to particular CTI information and the like. The screen events analyzer 66 detects predetermined screen events which can be used as events triggering the follow up interaction. Reference is made to PCT Patent Publication serial number WO02/073413A3 titled SYSTEM AND METHOD FOR CAPTURING, ANALYZING AND RECORDING SCREEN EVENTS, published 19 Sep. 2002 which provides a system for capturing and analyzing screen events. The interaction episode identifier 68 identifies an interaction episode based on the analyzed content of the interaction recording. The episode identified can be any one of a number of predetermined triggers, such as a CTI event, a media event, a screen event and the like. The interaction episode handler 70 collects the results provided by the interaction capture analyzer, such as the characteristics, selected content and context of the interaction episode. The episodes can be determined according to CTI information, or other events. Reference is made to PCT Patent Application serial number PCT/IL03/00684 titled APPARATUS AMD METHOD FOR AUDIO CONTENT ANALYSIS, MARKING AND SUMMING filed 18 Aug. 2003 which is incorporated herein by reference and provide details in relation to audio content analysis, marking and summing such content on the basis of meta data received from the audio channel itself or other media provided with the audio channel.

Referring now to FIG. 2B the information request generator 22 includes an information request selector 72, a feedback and action table entry assembler 74, an information request list handler 78, am interaction capture link builder 78, and an interaction episode link builder 80. Persons skilled in the art will appreciate that a single module or more than the number of modules shown can implement the above stated modules within the interaction request generator 22. The information request selector 72 is responsible for selecting an information request, such as a question or action, in accordance with the interaction associated with the interaction episode and optionally with characteristics, context or selected content of the interaction episode. The information request selector 72 selects an information request from the information request list 30 of FIG. 1. Such information requests are predefined and predetermined and include questions or answers specifically designed to be introduced to in expected circumstances. One such information request can be the question “Were you (the customer) upset when the representative put the call on hold?” The operative word here is “hold”. The information request will be easily associated with a hold CTI event detected by the system during or after the base interaction. Alternatively, the selector 72 further selects the information requests from an internal built-in table or could generate a request independently. Generating the information requests can be performed automatically through the use of various AI-like tools, such as text processing utilities applied to text generated from a speech to text utility applied to the capture received and other like tools enabling to automatically generate information requests. The information request built from various parts of an interaction request can be obtained by accessing information request list 30 of FIG. 1 and extracting specific words to be assembled into an information request. For example, in response to a CTI transfer event in the base interaction, the selector 72 can select a partially construed sentence such as “Did you (the customer) notice that the call was Field A?” where field A in this instance would be the CTI event word, which is “transferred”. Alternatively, the selector 72 can select each part of the sentence to be built from the information requests list 30 of FIG. 1 and construe a valid question or action. An example would be the selection of a base sentence such as “Did the Field B Field C you about Field D” and wherein Field B would be the identity of the representative, Field C the verb (such as ask, verify and the like) and Field D would be the subject, such as a particular service or product or problem or action. The construed information request could be “Did the representative ask you about our summer specials?” Alternatively, the selector 72 can use a sentence builder module to build the information requests from words provided in the information requests list 30 and the particular content, context or characteristics of the base interaction or the follow up interaction as identified by the interaction capture analyzer. The feedback and action table entry assembler 74 is functional in assembling a feedback and action table entry by utilizing one or more information requests previously selected or generated by the selector 72, and one or more pointer values generated in order to create links between the interaction episode and the information request entry and between the feedback and action table and the base interaction capture 16 of FIG. 1 or later follow up interactions. The feedback and action table may comprise various information requests or parts thereof, or words, or actions. The interaction capture link builder 78 marks the interaction capture 16 of FIG. 1 with a pointer value indicating the location of one or more feedback and action forms associated with the capture 16 and marking the feedback and action form with a pointer value indicating the location of the capture 16. The capture 16 may be later recorded and optionally stored and the pointer value will be updated accordingly to maintain the link between the interaction and the feedback and action form generated so as to maintain a direct link there between. The interaction episode link builder 80 is designed for marking the interaction episode with a pointer value indicating the location of one or more information request entries in the feedback and action form and for marking the one or more information request entries with a pointer value indicating the location of the interaction episode. While a particular manner of construing an information request is shown above, it will be clear to the person skilled in the art that like methods of creating information requests can be similarly used to construe information requests to be used in association with the present invention.

Referring now to FIG. 2C the follow-up interaction manager 26 responsible for the operation of the one or more follow-up interactions 40. The follow up interaction manager 26 comprises a follow-up interaction media selector 82, a feedback and action form presenter 86, an information request response handler 84, and an information request entry updater 88. Persons skilled in the art will appreciate that a single module or more than the number of modules shown can implement the above stated modules within the follow up interaction manager 26. The follow-up interaction media selector is operative in selecting the type and format of a media utilized for the performance of the follow-up interaction 40 of FIG. 1. Such media can include, but is not limited to, audio for use with a, cellular or telephone based systems, text for e-mail based systems, video or multimedia for data network based systems, The feedback and action form presenter 86 displays the information requests included in the feedback and action form to the participants 10, 14 of the follow-up interaction 40 of FIG. 1 in the media selected. Thus, persons participating in the follow up interaction via a data network based service will receive a web page comprising the feedback and action form while persons participating in the follow up interaction via voice based networks will receive an IVR type feedback and action form. The information request response handler 84 receives the responses (answers) of the participants to the presented information requests. The information request entry updater 88 inserts the received responses into the information request entry included in the feedback and action form.

Referring now to FIG. 3A the interaction information handler 28 includes a base interaction capture locator 90, an interaction episode locator 92, and an interaction capture-interaction episode-feedback and action form navigator 94. Persons skilled in the art will appreciate that a single module or more than the number of modules shown can implement the above stated modules within the interaction information handler 28. The capture locator 90 receives a request including a location reference and locates the capture 16 of FIG. 1 or the recording or storage of a base interaction 12 of FIG. 1 or of a follow up interaction. The interaction episode locator 92 locates an interaction episode associated with a base interaction 12 of FIG. 1 or a follow up interaction. The interaction capture-interaction episode-feedback and action form navigator 94 provides the option to the supervisors 44, 48 of FIG. 1 for selectively navigating and indirectly locating base or follow up interaction capture or recordings, and associated records of follow-up interactions. The navigation is enabled by the utilization of the links provided by the stored interaction identification values, stored the interaction episode location pointer values and the stored feedback and action form pointer values.

Referring to FIG. 3B the feedback and action form 96 includes form-specific data and one or more information request entries 106. The feedback and action form specific data includes a form identification 98 for uniquely identifying the feedback and action form. One or more participants identification 100 for uniquely identifying the participants of the interaction; a link to an associated interaction capture or recording 102 to enable direct access from the feedback and action form 96 to the base or follow up interaction recording 16 of FIG. 1. And one or more links to the interaction participants master records 104 to enable direct access to the participants' master files 36 of FIG. 1 from the feedback and action form 96. The information request entry 108 includes a link to an associated interaction episode 108, one or more information requests 110 associated with one or more respective interaction participants, and one or more responses to the information requests 112 associated with one or more respective interaction participants. Persons skilled in the art will appreciate that the feedback and action form can be construed of only information requests and in addition other types of data which can be used by the apparatus of the present invention. The above mentioned structure is shown as an exemplary feedback and action form provides additional and enhanced capabilities to the apparatus of the present invention.

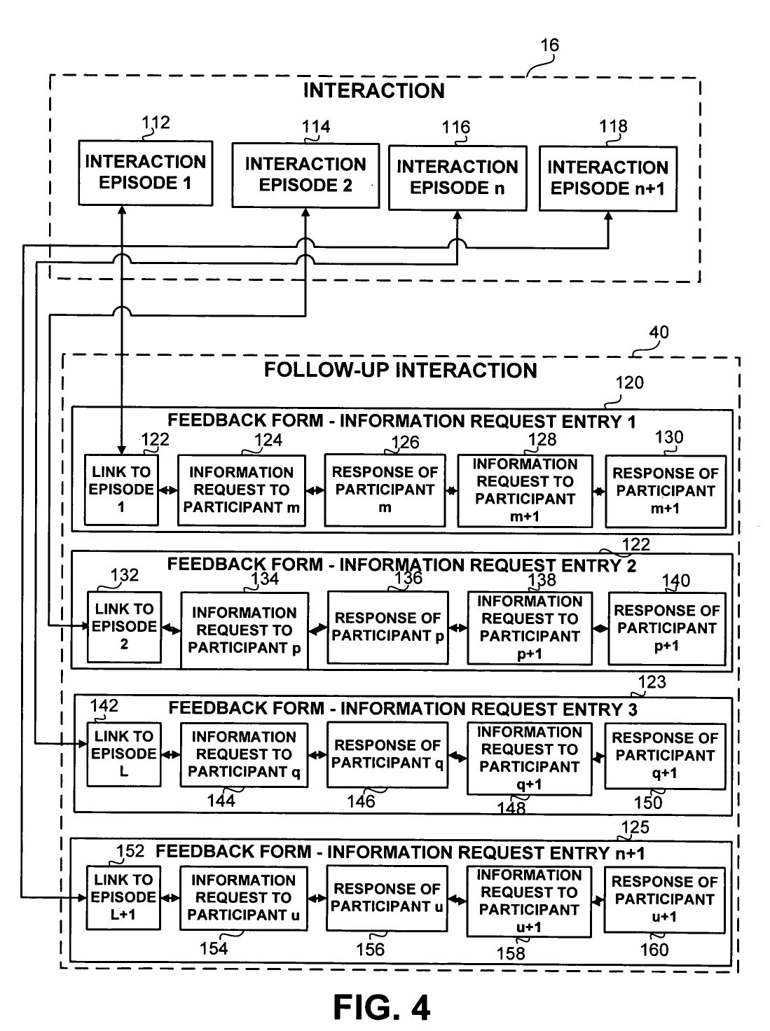

Referring to FIG. 3C the feedback and action form builder 24 includes a feedback and action form initializer 91, an information request entry record builder 93, an information request entry record updater 95, and a feedback and action form finalizer 97. Persons skilled in the art will appreciate that a single module or more than the number of modules shown can implement the above stated modules within the feedback and action form builder 24. The function of the feedback and action form initializer 91 is to create one or more new feedback and action forms 96 of FIG. 3B designed to be associated with an interaction episode 112, 114, 116, 118 of FIG. 4. In addition, the feedback and action form initializer 91 is responsible for the opening of the new feedback and action forms 96 as preparation for the insertion of the information request entries. The information request entry builder 93 receives groups of assembled information request entry fields from the information request generator 22 of FIG. 1 and inserts the groups of information request entry fields into one or more information request entry records 106 of FIG. 3B. The information request entry record updater 95 is responsible for inserting the information request entry records 106 into one or more feedback and action forms 96 of FIG. 3. The function of the feedback and action form finalizer 97 is to prepare the feedback and action forms 96 associated with the interaction episode 112, 114, 116, 118 of FIG. 4 and to insert the prepared feedback and action forms 96 of FIG. 3B into a feedback and action forms database 34 of FIG. 1.

Referring now to FIG. 4 the base interaction or a follow up interaction treated as a base interaction capture 16 includes one or more interactions such as interaction episode 1 (112), interaction episode 2 (114), interaction episode 3 (116), and interaction episode n+1 (118). Alternatively, the base interaction has been recorded and stored on a storage device such as a tape or hard disk or the like. Note should be taken that although the drawing under discussion shows only four episodes in a realistic environment an interaction recording could include a plurality of interaction episodes. The interaction capture 16 is generated by the capture of a base interaction 12 involving two or more active participants 10, 14. Alternatively, the interaction capture 16 is generated by the capture of a follow up interaction treated as a base interaction 12 involving two or more active participants 10, 14. In the preferred embodiment of the invention, the base interaction is an interaction or a service interaction taking place between one or more representatives associated with a call center, a service center, a virtual service center, and the like, and a customer. As noted above the present invention also intends to cover any other bi or multi-party interaction or interactions. The interaction is captured via various transmission media. Optionally, the interaction may be recorded and optionally also stored in order to provide for permanent records of the interaction. In the preferred embodiment of the present invention, one or more of the interaction episodes 112, 114, 116, 118 could be the source of one or more information requests 120, 122, 123, 125 in a feedback and action form. The finalized feedback and action form is a data structure generated by specific modules of the apparatus 18 of FIG. 1. The feedback and action form is utilized as a driver for a follow-up interaction 40 and as a depository of the information requests and participants responses to the requests where each information request and the associated response are connected to an interaction episode. As noted above information requests may include, but are not limited to questions, and actions to be performed by a party to the interaction, a third party or an automated machine. Thus, information request 120 is based on the interaction episode 1 (112), information request 122 is based on the interaction episode 2 (114), information request 123 is based on the interaction episode 3 (116), and information request 125 is based on the interaction episode 4 (118). Preferably, each interaction request entry 120, 122, 123, 125 includes several data fields, such as those described more specifically in association with FIG. 3B. In the preferred embodiment of the present invention, information request entry 120 includes a link to the interaction episode 1 (112) on which the entry 120 is based, an information request to one or more participants (124, 128), a response received from the one or more participants (126, 130). One non-limiting example would be the following: the interaction captured 16 would be a conversation between a customer and a representative of a financial institution wherein the customer requests information about a new service offered by the financial institution. The representative becomes upset with the customer and raises his voice during the conversation. The episode 112 is defined as ten seconds before and ten seconds after the high tones voiced by the representative. An information request 124 is generated in response to this episode to include the question “whether the customer believes the representative acted inappropriately when he raised his voice?” A feedback and action form (not shown) is generated to include the said information request. The feedback and action form is provided to the customer during or after the follow up interaction 40. The customer answers the information request and the answer 126 is stored and is linked to the episode 112 via link 122. Similar question 128 can be put to the representative and the response 130 stored and linked via link 122 to episode 112. A feedback and action form comprising a plurality of information requests can substitute single information requests 124, 128 and appropriate linking provided via multi-link 122 between each information request and each episode or between each feedback and action form and each episode. In addition, each information request can alternatively or in addition include an action item to be agreed upon or performed by the participant or by the apparatus 18 of FIG. 1. For example, if the representative was offering for sale a particular service and due to the interaction handling such service was not eventually sold, the follow up interaction information request can include an action which would offer the customer undergoing the follow up interaction to purchase the service offered. The response by the customer can be the trigger for automatically referring the customer to another representative for completing the sale, or completing the sale systems such as IVR or data network based commerce systems, such as a web site having a commerce capabilities. As noted below the interaction 16 can itself be a follow up interaction, so as to accomplish a follow up interaction on a previously executed or on an on going follow up interaction. The additional information request entries 122, 123, 125 include substantially the same fields and show that each interaction can potentially comprise an unlimited number of episodes and an unlimited number of information requests entry. Each information request entry may be recorded and stored for later examination and debriefing. During the examination of information collected regarding a specific interaction episode it is useful to compare the responses of the participants for better understanding of the events the entire set of participant-provided information stored in a single entry. Since handling a single entry is considerably easier than locating and comparing two or more entries storing more than one participant-provided information, a single entry is considerably more efficient than attempting to access two or more separate entries regarding the same interaction episode. In other preferred embodiments of the invention a separate information entry could be created for each participant regarding the same interaction episode. In yet other preferred embodiments several additional information requests and participant-provided responses could be stored in a single information request entry. The links 122, 132, 142, 152 connecting the information request entries 120, 122, 123, 125 to the interaction episodes 112, 114, 116, 118 generally include an interaction episode location value and a time reference or like link related information. The links are preferably two-way links where the interaction episodes 112, 114, 116, 118 are marked with links pointing to the respective information request entries 120, 122, 123, 125. Where more than one information request entry is generated for a single interaction episode then multi-way links are generated.

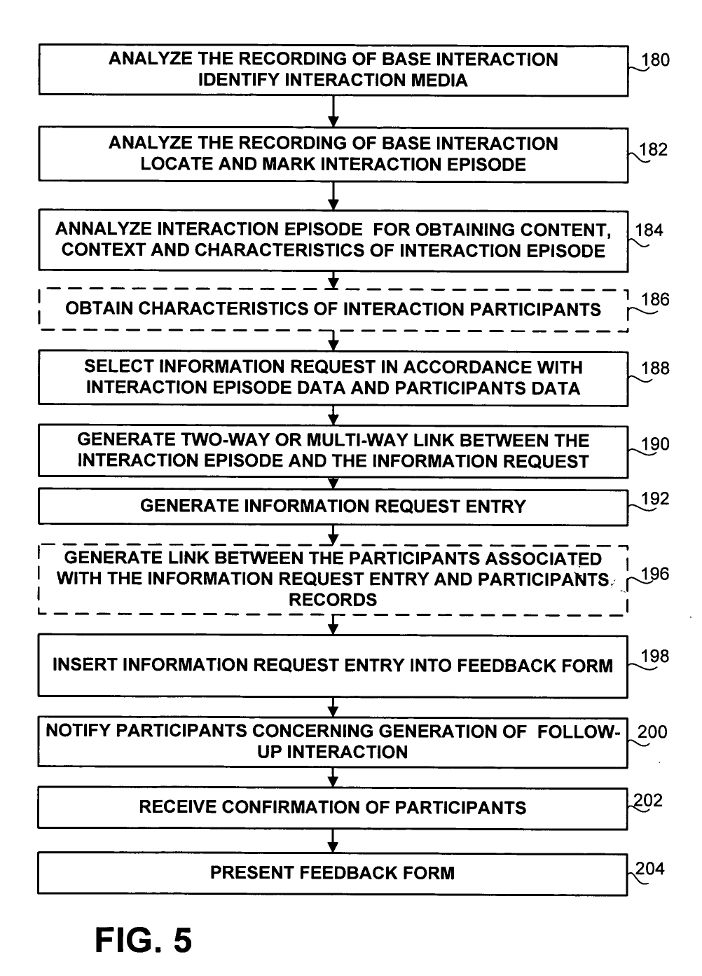

Referring now to FIG. 5 illustrating a simplified flow chart of the method for the analysis of the interaction capture, for the generation of the feedback and action form, and for the execution of the follow-up interaction. The process of generating the information requests and feedback and action forms and preparing the follow up interaction is preferably performed in real time and on the fly during the base interaction. The information requests can also be generated in off line mode once the capture has been stored, even in a temporary memory, and analyzed, or after the base interaction. The information requests can also be tuned up in real time during both the base interaction and the follow up interaction, as the answers of the participants are received and analyzed. For example, a set of questions may be dependant on the receipt of one answer, and if such answer is not received than the set of questions will not be introduced to the participant. And similarly, a series of questions can be added in response to a particular answer provided by the recipient to a particular question. The base interaction is continuously being captured and analyzed for events that will generate episodes for the follow up interaction. As noted above, the base interaction can itself be a follow up interaction. The following shows the process for the generation of the feedback and action form and for the execution of the follow-up interaction after at least a part of the interaction has been captured, such that such part can be analyzed and the follow up interaction prepared there after. The analysis of the captured interaction can begin a few seconds after the interaction begun on the captured section of the interaction. At step 180 the interaction capture is analyzed and the transmission media of the base interaction is identified. At step 182 the interaction capture is further analyzed and an interaction episode is located and marked in the base interaction capture. As noted above each episode corresponds predetermined events, such as CTI events, screen events, result of analyzers applied to the base interaction captured, such as word spotting, high emotions spotting, and the like. At step 184 the content of the interaction episode is analyzed for obtaining the relevant content, context and characteristics of the interaction episode. Optionally, at step 186 the characteristics of the interaction participants is obtained and at step 188 the optional participants information and the interaction episode data is utilized to select, to generate or to obtain one or more information requests. At step 190 a two-way or multi-way link is generated between the interaction episode and the one or more information requests and at step 192 the information request entries are assembled from the link values and the information requests. At step 196 a two-way or a multi-way link is generated between the interaction participants associated with the information request entries and an optional master records of the participants. At step 198 the assembled information request entry is inserted into a feedback and action form. At step 200 the participants of a base interaction are notified by the apparatus concerning the potential execution of follow-up interaction. The participants can be notified during or at the end of the base interaction. At step 202 the confirmation of the participants requested are received for the provision of the responses to the presentation of the feedback and action form. At step 204 one or more feedback and action forms presented to the participants agreeing to participate in the follow up interaction.

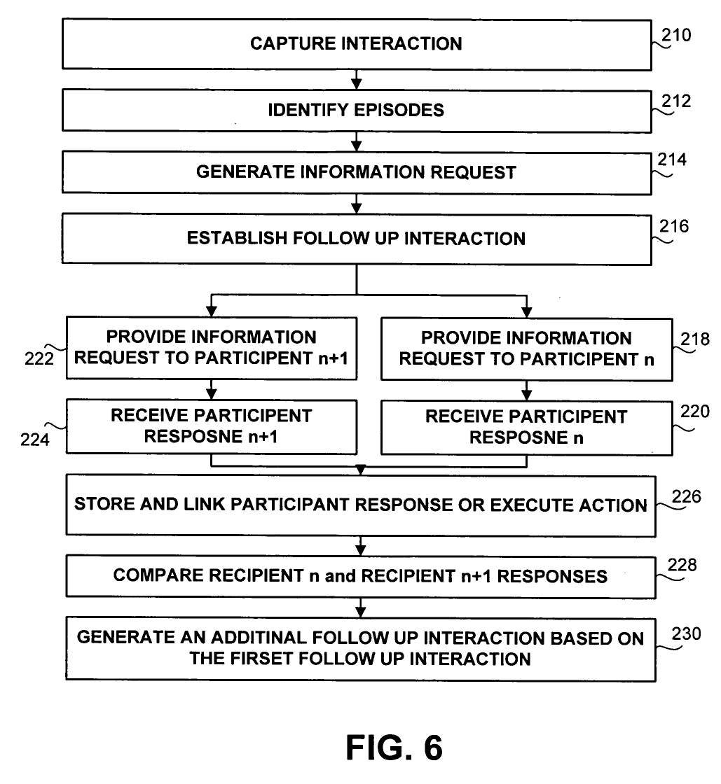

Referring now to FIG. 6 illustrating a simplified flow chart of the alternative method for the analysis of interactions captured, for the generation of the feedback and action form, and for the execution of the follow-up interaction. In step 210 the interaction is captured by the various capture means available, such as by microphones, video cameras, computerized devices such as the memory of a computing device and the like. In step 212 the parts of the captured interaction are analyzed to identify episodes. Episodes are determined according to predetermined events found during or after the analysis of the captured interaction. As noted above various events can be searched for and identified. For each identified event an additional predetermined part of the interaction is added to create an episode which includes a stream of audio, video or multimedia. For each episode, in step 214, one or more information requests are generated as is described in association with previous Figures. As noted above the information requests can include questions or actions and the like. The information request may be combined into a feedback and action form. In step 216 a follow up interaction is established with the participants of the base interaction or with other related parties, such as supervisors, managers, other representatives and the like. In step 218 the information request is provided to participant n and in step 220 participant n responds to the information request and the response is received and is stored. At the same time other participants or related parties such as participant n+1 can also receive the information request (step 222) and their response also received (step 224). In step 226 the participants of the follow up interaction responses are optionally stored and are linked to the episode identified and the base interaction. If the information request comprises an action and the response provided by the recipient is affirmative then in step 226 the action is performed. A list of exemplary actions was provided herein above. Optionally, in step 228 the various responses are compared one to the other. For example if the same questions have been put both to a customer and one or more representative than a table comprising a comparison of the answers can be generated so as to obtain an understanding of the episode handling. For example, a customer may answer that a representative behaved in a particular manner, while the representative can deny such behavior and the combination can provide a negative indication in a table to be provided and linked to the episode. The use of XOR and OR rules to create such a table will assist supervisors in immediately assessing inconsistencies between the customer and the representative. Such inconsistencies can be easily investigated by clicking on the link provided from the response or such table directly to the episode and the base interaction. In addition, in step 230 a second follow up can be generated on the basis of the first follow up interaction. In the example provided above it is likely that additional questions may be desirable to obtain additional information from the participants. In addition, if in a follow up interaction it is discovered that certain items have not been performed during or after the base interaction, than the second follow up interaction can include actions which will offer and assist the customer or the representative to complete that which has not been done during or after the base interaction or to receive additional information or accomplish any task related to the base interaction.

In accordance with the preferred embodiment of the invention, consequent to the performance of the base interaction and the generation of one or more feedback and action forms an at least one follow-up interaction is executed involving one or more base interaction participants. The follow-up interaction is driven by one or more feedback and action forms created during or after the base interaction. The follow-up interaction is utilized for obtaining interaction information regarding the events occurred during or after the base interaction where the events are associated with an interaction episode. The base interaction can also be a follow up interaction so that follow up interactions can be performed on follow up interactions.

The answers obtained during the follow-up interaction are inserted into the appropriate information request entries in the feedback and action form. The completed feedback and action forms provide interaction information that would be accessed during consequent interaction examination. The forms could be accessed, displayed and examined by interaction information examiners, such as operations supervisors, junior managers, auditors, external investigators and the like. The two-way or multi-way links generated during the feedback and action form creation and information request entries formation provide for ready navigating across the interaction recordings, the associated feedback and action forms, the interaction episodes, the associated information request entries, and the participants master files.

The type and characteristics of the interaction episodes operative in the generation of the information request entries could be permanently pre-defined or could be dynamically defined prior to the generation of the feedback and action form. In order to assign one or more information requests (questions) to an interaction episode the information requests could be generated dynamically and adaptively where the generating process is based on the following non-limiting parameters: a) The contents and context of the interaction episode, b) diverse external and/or internal data, c) historical and/or current interaction or interaction information data, d) content analysis data e) complexity of the interaction content, f) participants' accent, g) participants' dialect, h) participants' tone, i) participants' clarity of speech, j) number of questions introduced, k) order of questions introduced and l) the answers provided by the participant of the survey provided. Information requests could be further selected from a pre-defined set of information requests. The follow up interaction is initiated for all the participants of the base interaction, such as customers, representatives, agents, and the like. During or after the follow up interaction the server may generate on the fly additional questions to be added to the feedback and action form being answered or pursued. Thus, when am information request (such as a question) is being asked and the participant answers the information request the apparatus 18 will immediately analyze the answer received and generate an additional information request based on the answer received and will then incorporate the new information request into the follow up interaction now being conducted. This means that instead of having follow up interactions with respect to follow up interactions the apparatus 18 will continue to investigate the episode and the follow up interaction by continuously introducing information requests or actions until no events (whether in the base or in the follow up interactions) are left to interrogate. This

It will be appreciated by persons skilled in the art that the present invention is not limited to what has been particularly shown and described hereinabove. Rather the scope of the present invention is defined only by the claims which follow.

1. An apparatus for the acquirement of interaction related information, the apparatus comprising the elements of:
an interaction capture handler for capturing and analyzing an at least one interaction to identify an at least one episode within the at least one captured interaction;
an information request generator for generating an at least one information request associated with the at least one interaction episode;
a feedback and an action form builder for building an at least one feedback and an action form associated with the at least one captured interaction and including the at least one information request associated with the at least one episode.

2. The apparatus of claim 1 further comprising a follow-up interaction manager for receiving and handling a response to the at least one information request in the at least one feedback and action form.

3. The apparatus of claim 2 wherein the information request generator generates an at least one information request associated with the at least one interaction episode generated during or after the follow-up interaction.

4. The apparatus of claim 1, wherein the interaction capture handler comprises the elements of:
an interaction media identifier for identifying the type and format of the recorded base interaction;
an interaction capture analyzer for analyzing the contents of the interaction capture,

5. The apparatus of claim 4 wherein the interaction capture handler further comprises the element of an interaction participant identifier for identifying the participant or the characteristics of the interaction participant.

6. The apparatus of claim 1, wherein the interaction capture handler comprises the elements of: an interaction episode identifier for identifying an interaction episode in the capture of the base interaction; and
an interaction episode processor for collecting and extracting the characteristics and selected content of the identified interaction episode.

7. The apparatus of claim 4, wherein the interaction capture analyzer is one of the following: an audio analyzer; a word spotter apparatus; an emotion detector apparatus; a talk analyzer; a speech to text analyzer a computer telephony integration data analyzer.

8. The apparatus of claim 1, wherein the information request generator comprises the element of an information request selector for selecting an at least one information request in accordance with the characteristics of the at least one interaction episode.

9. The apparatus of claim 1 wherein the the information request generator is activated where at least a part of the at least one interaction is captured.

10. The apparatus of claim 1, wherein the information request generator comprises the element of a feedback table entry assembler for assembling an at least one feedback table entry utilizing the at least one information request record, a pointer value indicating the location of the at least one interaction episode, and an identification value to indicate the identification of the interaction capture.

11. The apparatus of claim 1 wherein the information request is a question or action to be performed.

12. The apparatus of claim 11 wherein the question or action to be performed are generated in response to a response to an information request presented to a participant.

13. The apparatus of claim 1 further comprises the elements of:
an base interaction capture link builder for marking the capture of the base interaction with a pointer value indicating the location of the at least one feedback and action form; and
an interaction episode link builder for marking the at least one interaction episode with the pointer value indicating the location of the at least one information request entry.

14. The apparatus of claim 2, wherein the follow-up interaction manager comprises the elements of
a follow-up interaction media selector for selecting the type and format of media utilized for the performance of an at least one follow-up interaction;
a feedback and action form presenter for presenting the at least one information request associated with at least one feedback and action form to an at least one base interaction participant associated with an base interaction;
an information request response handler for receiving a response to the at least one information request from the at least one base interaction participant; and
an information request entry updater for inserting the received response into the at least one information request entry in the at least one feedback and action form.

15. The apparatus of claim 1 further comprising an interaction information handler comprising the elements of:
an base interaction capture locator for locating by reference the capture of an at least one base interaction;
an interaction episode locator for locating an at least one interaction episode associated with the at least one base interaction;
a follow-up interaction locator for locating an at least one feedback and action form associated with the at least one base interaction; and
an base interaction capture-interaction episode-feedback and action form navigator for selectively navigating and indirectly locating the associated base interaction recording and the records of the follow-up interactions by utilizing the logical links provided by the interaction identification values, the interaction episode pointer values, and the feedback and action form pointer values.

16. A method for obtaining interaction related information and conducting a follow up interaction, the method comprising the steps of:
analyzing a base interaction for identifying an at least one base interaction episode occurring during or after the base interaction;
selecting an at least one information request in accordance with at least one characteristic of the at least one base interaction episode;
executing an at least one follow-up interaction with an at least one interaction participant, utilizing the at least one information request generated during or after the base interaction, for obtaining interaction information regarding the events occurred.

17. The method of claim 16 further comprising the step of inserting the at least one information request into an at least one feedback and an action form.

18. The method of claim 16 further comprises the step of executing an at least one follow-up interaction with an at least one interaction participant, utilizing the at least one information request generated during or after the base interaction, for obtaining interaction information regarding the events occurred.

19. The method of claim 16 further comprises the step of executing an at least one follow-up interaction with an at least one interaction participant, utilizing the at least one feedback and action form generated during or after the base interaction, for obtaining interaction information regarding the events occurred.

20. The method of claim 16 further comprises the step of executing an at least one follow-up interaction with an at least one interaction participant, utilizing the at least one information request generated after the base interaction is complete, for obtaining interaction information regarding the events occurred.

21. The method of claim 16 wherein the step of analyzing is performed during or after the interaction.

22. The method of claim 16 wherein the base interaction is a follow up interaction.

23. The method of claim 16 wherein an information request is a question or an action.

24. The method of claim 16 further comprising the steps of creating a logical link between the at least one interaction episode and the at least one information request.

25. The method of claim 16 further comprising the steps of creating a logical link between the at least one interaction episode and the at least one information request.

26. The method of claim 17 further comprising the steps of creating a logical link between the at least one interaction episode and the at least one information request and creating a logical link between the base interaction and the at least one feedback and action form.

27. The method of claim 16 wherein the step of analyzing the capture of the base interaction comprises the steps of:
identifying the transmission media utilized for the performance of the base interaction; and
locating an at least one interaction episode in the capture of the base interaction, the at least one interaction episode associated with an at least one event occurring during or after the base interaction.

28. The method of claim 16, wherein the base interaction is an interaction for exchanging content information between an at least one customer and an at least one representative.

29. The method of claim 16, wherein the characteristics of the at least one interaction episode are defined during base interaction.

30. The method of claim 16, wherein the at least one information request is selected in accordance with the characteristics, selected content and context of the at least one interaction episode.

31. The method of claim 17 wherein the step of inserting the at least one information request into an at least one feedback and an action form is performed during the base interaction or during the follow up interaction.

32. The method of claim 18 further comprises the steps of:
notifying at least one participant of the base interaction regarding the execution of the follow-up interaction;
requesting confirmation for the provision of responses to the presentation of the at least one feedback and action form associated with the at least one follow-up interaction from the at least one participant of the base interaction;
logically linking the at least one feedback and action form with a customer's master record; and
logically linking the at least one feedback and action form with a representative's master record.
